(19) United States
(12) Patent Application Publication
(10) Pub. No.: US 2010/0019987 A1
(43) Pub. Date: Jan. 28, 2010

(54) Normal Mode Helical Antenna

(75) Inventors: Yoshihide Yamada, Kanagawa (JP); Naobumi Michishita, Kanagawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Yoshihide Yamada; Naobumi Michishita; Mighty Card Corporation

(21) Appl. No.: 12/179,220

(22) Filed: Jul. 24, 2008

(51) Int. Cl. H01Q 1/36

(52) U.S. Cl. 343/895

(57) ABSTRACT

A normal mode helical antenna comprises a coil made by winding a first conductor helically, and a second conductor shorter than the first conductor having a feeding point at the middle thereof. The second conductor is disposed outside of the coil at a center part in a longitudinal direction thereof along the first conductor. Both ends of the second conductor are connected to the first conductor of the coil.

### CROSS-REFERENCE TO RELATED APPLICATIONS

The present application is related to Japanese Patent Application No. 2006-13150 filed on Jan. 20, 2006, the entire content of which is herein incorporated by reference.

### BACKGROUND OF THE INVENTION

1. Field of the Invention

This invention relates to a normal mode helical antenna to be used for a small wireless tag in ubiquitous communications, a small wireless sensor suitable for embedding in a living body, and the like, that has a function of radiating a radio wave out in space from a conductor part through application of a high frequency voltage to a feeding part thereof.

2. Related Art

In ubiquitous communications, an attempt has been made to improve the distribution of goods by providing goods traded at sales sites with a tag that can be identified by a radio wave, that is, an RFID (Radio Frequency IDentification) tag.

Important issues in commercial application of such an RFID tag are reducing its size and improving its sensitivity to radio waves. Accordingly, small antennas of various types have been developed so as to cope with the above issues.

Specifically, there is known a normal mode helical antenna that is suitable for the aforesaid usage purpose. See, for example, Japanese Patent Application Laid-open Publication No. 2001-94333, and Klaus Finkenzeller, “RFID Handbook”, 2nd edition, THE NIKKAN KOGYO SHIMBUN, LTD., pp. 12-13. As shown in FIG. 1 of the present disclosure, the basic structure of a normal mode helical antenna 200 is its helical structure, obtained by winding a thin conductive wire 100 into a coil shape. (Hereinafter, in this specification, this structure will be simply referred to as “helical structure” or “basic structure”.) In the helical structure, electric power is fed at a feeding point 110 at the middle of the coil. Here, in the helical structure, an antenna length, an antenna radius, a radius of the conductive wire 100, and a number of turns are referred to as H, a, d, and N, respectively.

A distinctive feature of the normal mode helical antenna 200 is its ability to achieve pure resistive input impedance through canceling a large capacitive reactance caused by reduction of the size of the antenna by an inductive reactance of a coil. Therefore, the normal mode helical antenna 200 is suitable for a very small antenna, a physical size of which may be several tenths that of the working wavelength. It is to be noted that a condition in which an input impedance is purely resistive is called self-resonance.

In order to accomplish the above feature, it is required to appropriately determine and set a relationship between an antenna length H, an antenna diameter 2a, and a number of turns of an antenna N.

Alternatively, as shown in FIG. 2, a structure is proposed in which two helical structures 200 are disposed in parallel to each other and both ends of one helical structure 200 are connected to respective ends of the other helical structure 200 by conductors. The antenna of this type is called a normal mode helical antenna 210 with a folded structure, hereinafter simply referred to as “folded structure”. See, for example, Tei, Michishita, Yamada, “Performance of High Efficiency Ultra-small Normal Mode Helical Antenna”, IEICE Technical Report, September 2005, AP2005-69, pp. 25-30.

In the helical structure 200 in FIG. 1 and the folded structure 210 in FIG. 2, calculated results of input impedance are shown in FIG. 3, where H=0.025λ, 2a=0.016λ, N=10, and the diameter 2d of the conductive wire 100 is 0.16 mm. Here, the symbol λ stands for wavelength. In both the helical structure 200 in FIG. 1 and the folded structure 210 in FIG. 2, resonance occurs at 900 MHz of frequency and the input impedance of the antennas is purely resistive. In the results, a resistance value of the folded structure 210 is measured as 5.334Ω that is higher than 2.146Ω measured in the helical structure 200. Accordingly, it becomes possible to bring an input impedance of an antenna toward an impedance of a feeder, 50Ω. However, the resistance values of the both structures are still very much smaller than the impedance of the feeder.

As a technique of matching these small resistance values to the impedance of a feeder, there is a normal mode helical antenna 220 of a tap feeding structure, hereinafter simply referred to as “tap feeding structure”, as shown in FIG. 4A. See, for example, J. D. Klaus, “Antennas”, Second Edition, McGraw-Hill, 1988, p. 337. As shown in FIG. 4A, a lower half part of the antenna is terminated by a conductive plate 120. As a result, with respect to electrical characteristics, the antenna in FIG. 4A is equivalent to the structure shown in FIG. 4B.

Based on the example described in the above reference, calculated input impedance is shown in FIG. 5, where H=120 mm, 2a=13 mm, N=12, and the diameter of the conductive wire is 0.2 mm. In the tap feeding structure 220, the input impedance of approximately 40Ω can be obtained that is close to the impedance of a feeder, whereas the input impedance as obtained is approximately 10Ω in the case in which the tap feeding structure is not employed. Here, a tap size is set such that L1=20 mm and L2=40 mm. With respect to a self-resonant frequency, in the tap feeding structure 220, 493 MHz is obtained, whereas 393 MHz is obtained in the case in which the tap feeding structure is not employed. When f=493 MHz is used as the working frequency of the antenna, the antenna length H=120 mm corresponds to H=0.197λ. This antenna length relative to wavelength is relatively long considering that the antenna is of the normal mode helical antenna type, and it is possible to bring the input impedance value equal to 50Ω of the feeder impedance by increasing L2.

Here, in the structure in FIG. 4B, an approximate evaluation can be made regarding an effect of improving the input impedance by employing the tap feeding in accordance with a transmission line model shown in FIG. 6A. Calculation formulas for the evaluation are shown below. See, for example, C. A. Balanis, “Antenna Theory, Analysis and Design”, Second edition, J. Wiley and Sons Inc., 1982, pp. 472-475.

First, a ratio α of a current flowing through the antenna to that in the tap is obtained by the following Formula (1):

$$α = \frac{ln ( s / {a}^{′} )}{ln ( s / {a}^{′} ) - ln ( a / {a}^{′} )} \qquad ( 1 )$$

where symbols a and a′ are respectively diameters of the antenna and the tap.

Next, an impedance Zₜ of the transmission line is described below in Formula (2) by using a line length up to a terminal of the tap, l₁/2,

$${Z}_{t} = j {Z}_{0} tan ( k \frac{{l}_{1}}{2} ) \qquad ( 2 )$$

where Z₀ is a characteristics impedance of a transmission line having radiuses a, a′, and a distance s. Z₀ is calculated by Formula (3) below:

$${Z}_{0} = 276 {log}_{10} ( \frac{s}{\sqrt{{aa}^{′}}} ) \qquad ( 3 )$$

Resultantly, an input impedance Zᵢₙ is obtained as in Formula (4) below:

$${Z}_{in} = \frac{2 {Z}_{t} [ {( 1 - α )}^{2} {Z}_{a} ]}{2 {Z}_{t} + {( 1 + α )}^{2} {Z}_{a}} = {R}_{in} + j {X}_{in} \qquad ( 4 )$$

where Zₐ is an input impedance of an antenna without a tap.

Calculated results of Rᵢₙ in Formula (4) according to sizes of the related parts of the structure in FIG. 4B and Zₐ=10.5Ω is shown in FIG. 6B. Symbols of “triangle” and “X” in FIG. 6B indicate calculated values using an electromagnetic field simulator. As seen from the figure, the calculated values according to Formulas (1)-(4) well conform to the values obtained by the electromagnetic field simulator. It is appreciated from FIG. 6B that a distance between the feeding points, 1, needs to be set substantially long, more specifically equal to or longer than 40 mm, so as to increase the input impedance of the antenna to close to the 50Ω of the feeder impedance.

The aforementioned tap structure will be applied to the ultra-small normal mode helical antenna of 0.05 wavelength. A structure in which tap feeding is made in the helical structure 200 in FIG. 1 is shown in FIG. 7B. Here, L1=20 mm and L2=20 mm are applied. The input impedance has been slightly increased by the tap feeding. However, since the value without tap feeding is as small as 2.146Ω, the input impedance after increasing by the tap feeding remains around 5Ω.

If L1 and L2 are increased, an input impedance will be increased accordingly. However, in that case, a size of the tap portion may be too large relative to the antenna length of 50 mm. In addition, it is very difficult to increase the input impedance up to the 50Ω feeder impedance. Consequently, according to the existing tap feeding structure, it is very difficult to increase an input impedance of an ultra-small normal mode helical antenna smaller than or equal to 0.05 wavelength, and thus impedance matching a feeder cannot be effectively carried out for those antennas.

As described above, in a normal mode helical antenna of about 0.2 wavelength in length, it is relatively easy to have the input impedance matched with the 50Ω feeder impedance since the tap portion length is allowed to be substantially long. However, in a normal mode helical antenna, in which the length is less than or equal to 0.05 wavelength, it is difficult to give a sufficient length to a tap portion and therefore a resistance value thereof cannot be sufficiently increased, thus matching the 50Ω feeder cannot be accomplished. As explained above, in a normal mode helical antenna, it is sometimes difficult to realize a required input impedance due to restriction on antenna size.

### SUMMARY OF THE INVENTION

The present invention has been made in view of the above and other problems. An object of the present invention is to provide a normal mode helical antenna that realizes a required input impedance regardless of restriction based on its size.

One aspect of the present invention for solving the above and other problems provides a normal mode helical antenna comprising a coil made by winding a first conductor helically; and a second conductor shorter than the first conductor having a feeding point at the middle thereof, the second conductor disposed outside of the coil at a center part in a longitudinal direction thereof along the first conductor, with both ends of the second conductor connected to the first conductor of the coil.

According to the present invention, it is possible to provide a normal mode helical antenna that realizes a required input impedance regardless of restriction based on its size.

### BRIEF DESCRIPTION OF THE DRAWINGS

FIG. 1 shows a normal mode helical antenna having a basic structure;

FIG. 2 shows a normal mode helical antenna having a folded structure;

FIG. 3 is a chart showing input impedance characteristics of a normal mode helical antenna;

FIGS. 4A and 4B show a normal mode helical antenna having a tap feeding structure;

FIG. 5 is a chart showing an effect to input impedance characteristics by employing tap feeding;

FIG. 6A shows a transmission line model employing tap feeding;

FIG. 6B is a chart showing Rᵢₙ as calculated as to the model shown in FIG. 4B;

FIG. 7A shows an ultra-small normal mode helical antenna with tap feeding;

FIG. 7B is a chart showing an input impedance of the antenna shown in FIG. 7A;

FIG. 8 shows a normal mode helical antenna having a basic structure according to one embodiment of the present invention;

FIG. 9 shows a normal mode helical antenna having a basic structure according to one embodiment of the present invention;

FIG. 10 is a chart showing an input impedance of a normal mode helical antenna having a basic structure according to one embodiment of the present invention;

FIG. 11 shows a normal mode helical antenna having a folded structure according to one embodiment of the present invention;

FIG. 12 is a chart showing an input impedance of a normal mode helical antenna having a folded structure according to one embodiment of the present invention;

FIG. 13A is a chart showing an input impedance of a normal mode helical antenna having a basic structure according to one embodiment of the present invention;

FIG. 13B is a chart showing an input impedance of a normal mode helical antenna having a folded structure according to one embodiment of the present invention;

FIG. 14A is a chart showing antenna radiation characteristics of a normal mode helical antenna having a basic structure according to one embodiment of the present invention;

FIG. 14B is a chart showing antenna radiation characteristics of a normal mode helical antenna having a folded structure according to one embodiment of the present invention;

FIG. 15 shows a normal mode helical antenna having a basic structure according to one embodiment of the present invention.

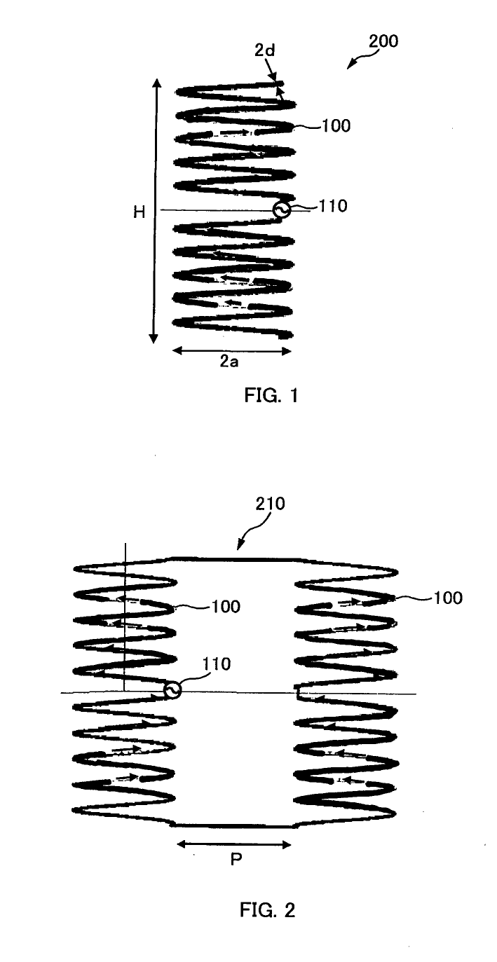

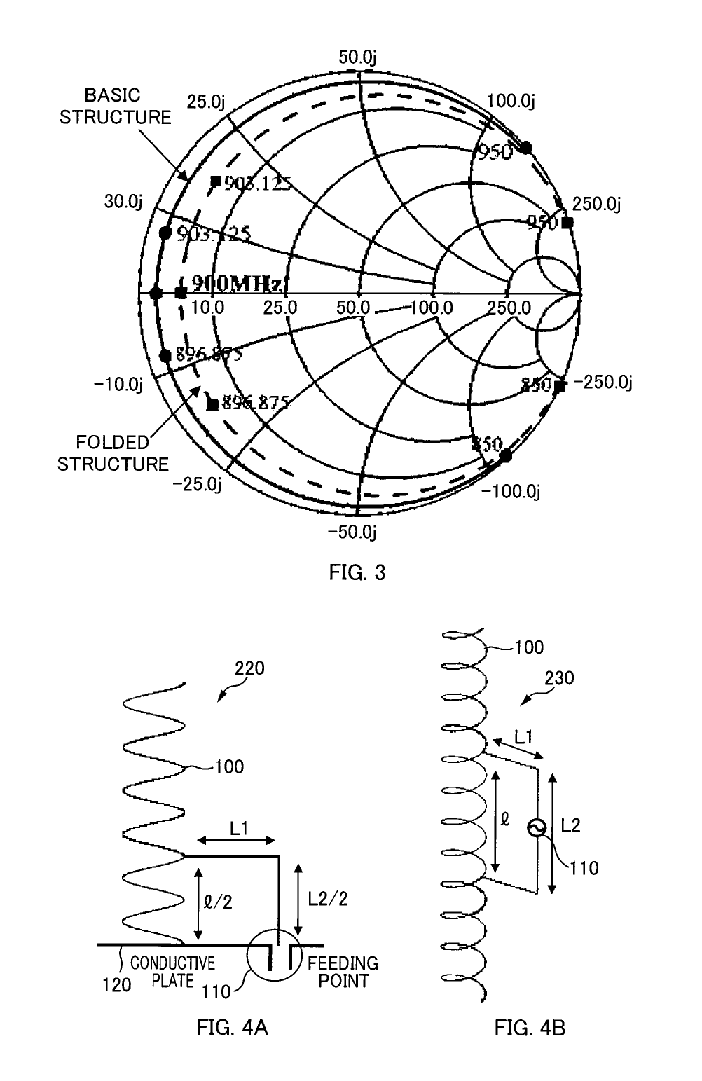

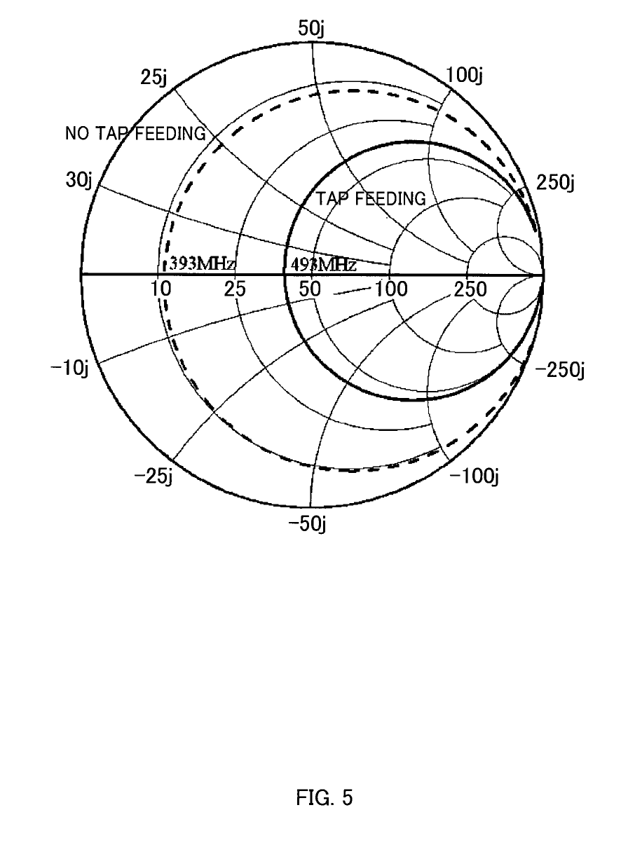

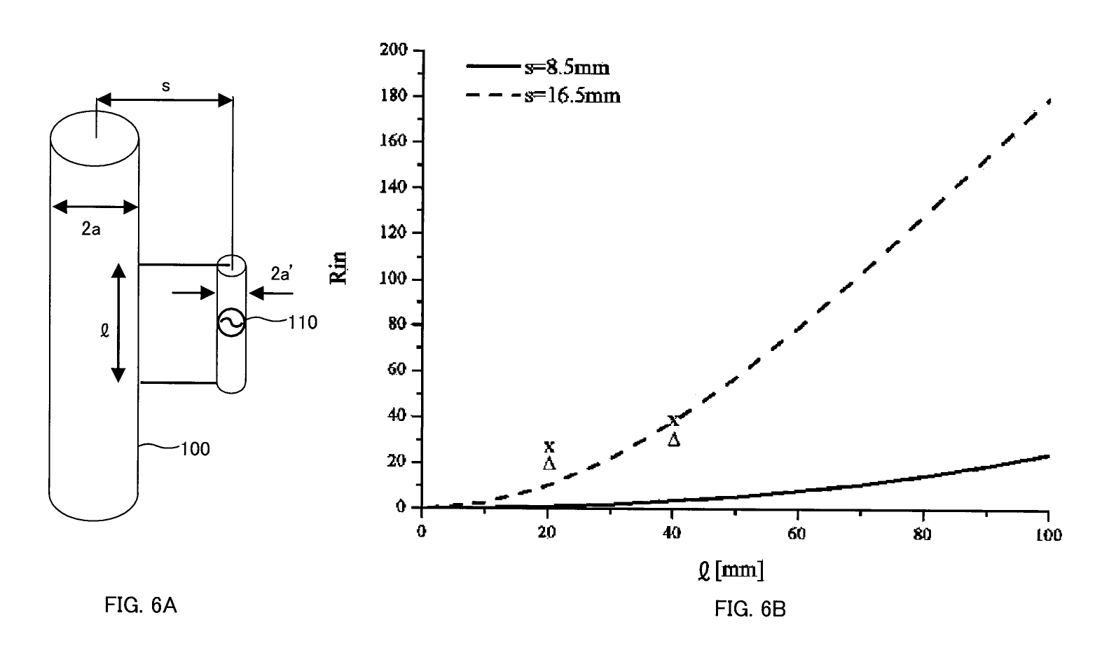

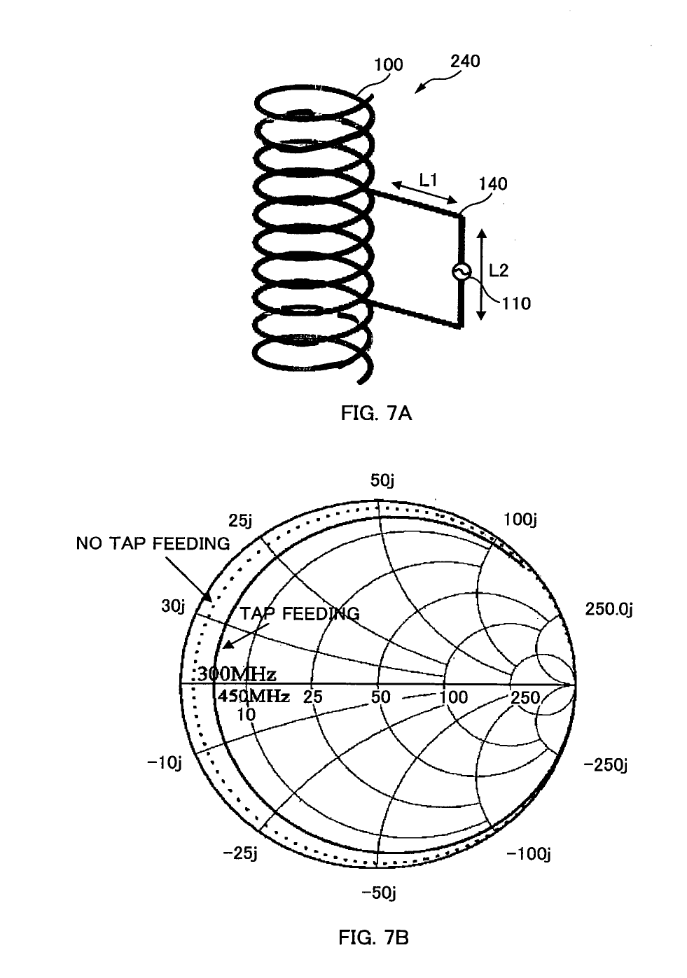

### DETAILED DESCRIPTION OF THE INVENTION

Now, embodiments of the present invention will be described below in detail with reference to the accompanying drawings.

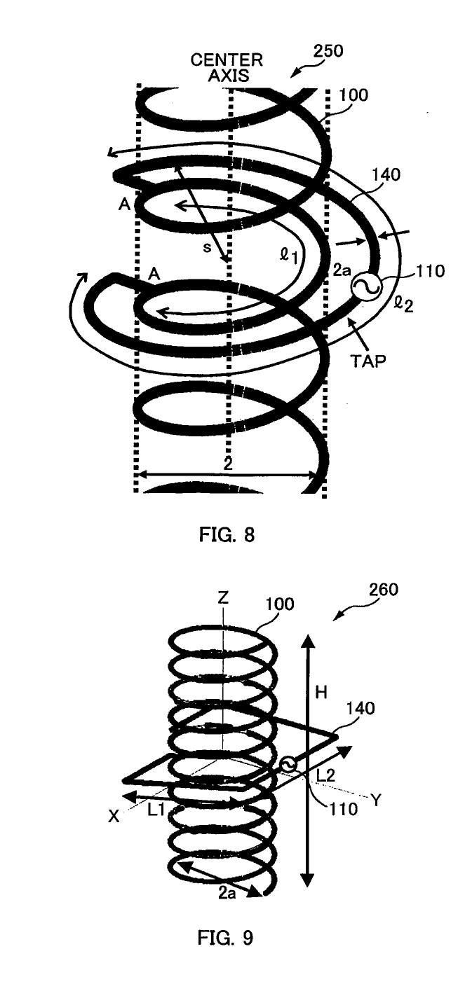

FIG. 8 shows a normal mode helical antenna 250 according to one embodiment of the present invention. As shown in FIG. 8, the normal mode helical antenna 250 comprises a coil made by winding a first conductor 100 helically, and a second conductor 140 shorter than the first conductor 100 having a feeding point 110 at the middle thereof. The second conductor 140 is disposed outside of the coil at a center part in a longitudinal direction thereof along the first conductor 100, and both ends of the second conductor 140 are connected to the first conductor 100. A tapping wire 140 as the second conductor is disposed along the wire 100 as the first conductor forming the normal mode helical antenna 250.

Please note that in FIG. 8 the feeding points to the antenna 250 are indicated by A and A′, and a distance between the feeding points is indicated by l₁. As shown in FIG. 8, in the basic structure of tap feeding the second conductor 140 is disposed adjacent the first conductor 100 while a distance between the first and the second conductors is kept constant. According to this structure, increase in size of the antenna due to employment of tap feeding can be minimized.

Alternatively, the structure 260 shown in FIG. 9 may be employed. In the structure 260 in FIG. 9, the second conductor 140 is wound along the first conductor 100 so as to have a linear portion. This structure facilitates manufacturing of the helical antenna shown in FIG. 9.

The structure 260 in FIG. 9 was analyzed with respect to electrical characteristics according to the method of moments using an electromagnetic field simulator “FEKO” commercially available from EM Software & Systems, South Africa. The analysis was carried out under an applied frequency of 300 MHz, H=54 mm, 2a=19 mm, N=10, and a conductor diameter 2d=1 mm.

In the structure 260 in FIG. 9, variation in an input impedance according to variation of the distance between the feeding points, l₁ is shown in FIG. 10. In FIG. 10, the length of the coil per one turn is indicated by symbol C. l₁ was varied between C/4 and 1.5C. In each impedance locus a frequency of 298-302 MHz is applied. Each black bullet symbol indicates a point of 300 MHz. When the tap was provided so that L₁ is equal to C, the input impedance was successfully increased from 2.38Ω to 42.14Ω where L1=L2=30 mm.

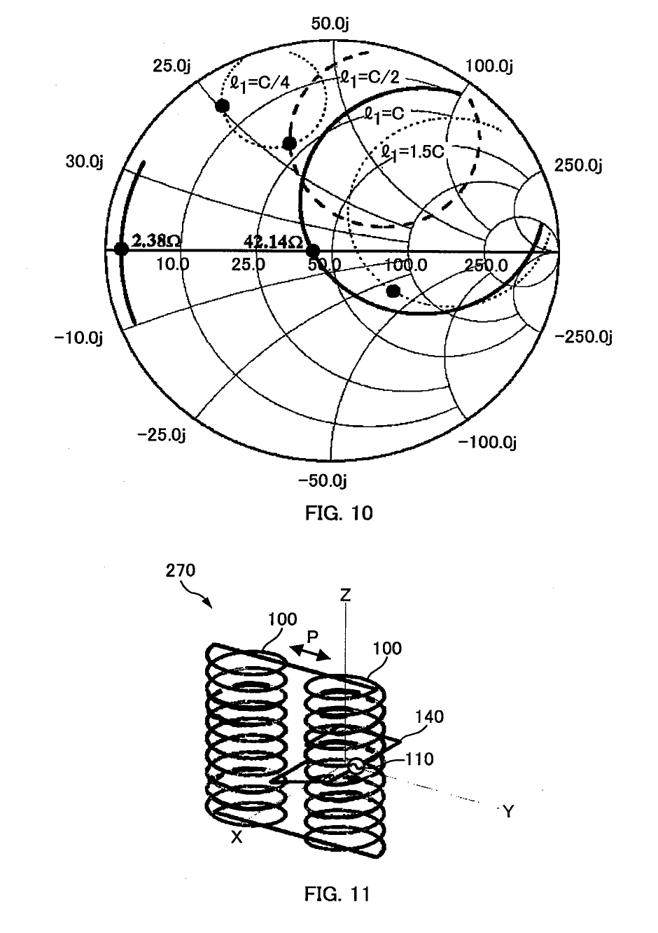

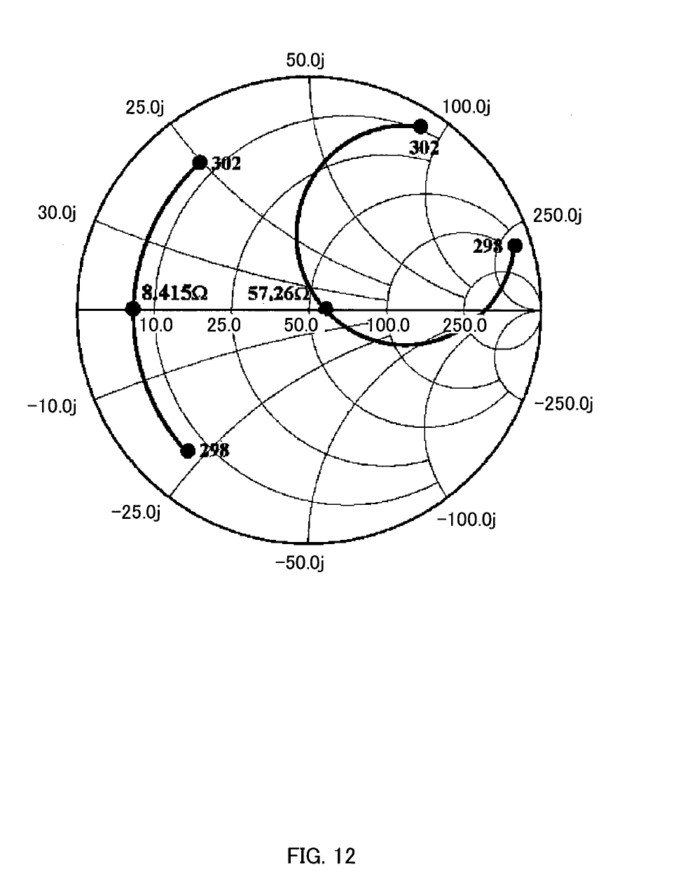

Next, in the folded structure 270 in FIG. 11, an effect of tap feeding was calculated. The folded structure 270 in FIG. 11 comprises a first coil made by winding a first conductor 100 helically and a second coil made by winding a third conductor 100 helically. The second coil is disposed at a plane-symmetric position with respect to the first coil so that a center axis thereof is parallel to a center axis of the first coil. The ends of the second coil positioned plane-symmetrically with respect to the ends of the first coil are connected to the ends of the first coil respectively.

An effect of tap feeding on the input impedance for the folded structure 270 is illustrated in FIG. 12. In this case, so that self-resonance is achieved for the folded structure 270, a distance P between the first and third coils was set at an appropriate value of 20 mm. The tap structure was made identical to that of the structure in FIG. 9 with respect to size. In this folded structure 270, the input impedance of 8.42Ω without tap feeding was successfully increased to 57.26Ω by tap feeding.

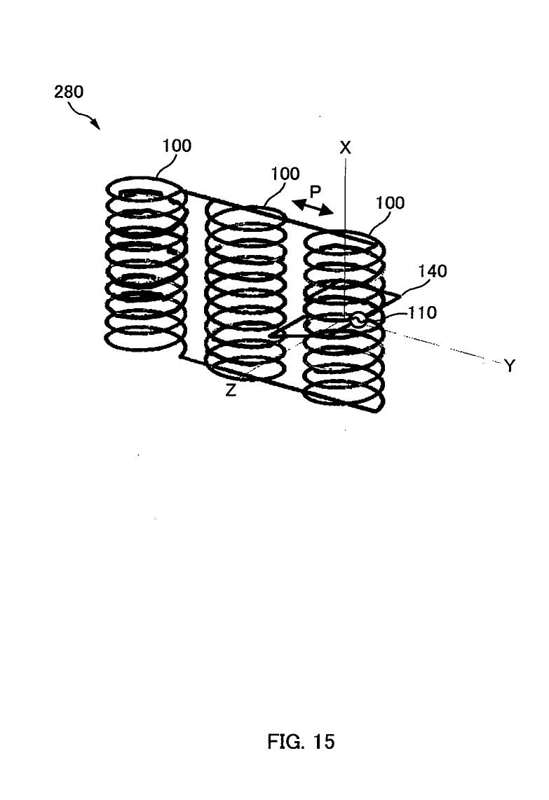

As shown in FIG. 15, a plurality of second coils may be provided. It is expected that this configuration can enhance increase of the input impedance.

Next, for the basic structure 260 and the folded structure 270, variation in an input impedance Rᵢₙ, an antenna efficiency η, and an antenna gain Gr with and without tap feeding is shown in Table 1. The input impedance Rᵢₙ is a sum of a radiation resistance Rr and a conductor resistance Rl.

TABLE 1
Comparison of Electrical Characteristics in Basic
and Folded Structures With/Without Tap Feeding

| | | Rin | Rr | Rl | η | Gr |
|---|---|---|---|---|---|---|
| Basic | No Tap | 2.384 Ω | 1.35 Ω | 1.034 Ω | −2.5 dB | −10.1 dBd |
| Structure | With | 42.14 Ω | 29.82 Ω | 12.32 Ω | −1.5 dB | −1.53 dBd |
| | Tap | | | | | |
| Folded | No Tap | 8.415 Ω | 6.141 Ω | 2.274 Ω | −1.4 dB | −4.5 dBd |
| Structure | With | 57.26 Ω | 43.02 Ω | 14.24 Ω | −1.24 dB | −1.26 dBd |
| | Tap | | | | | |

In the basic structure 260, increase in Rr is greater than increase in Rl, and the antenna efficiency η has been improved by 1 dB by tap feeding. In the folded structure 270, it is observed Rr and Rl are equally increased. In the both structures, matching with a 50Ω feeder was achieved and the antenna gain Gr has become equal to the antenna efficiency η.

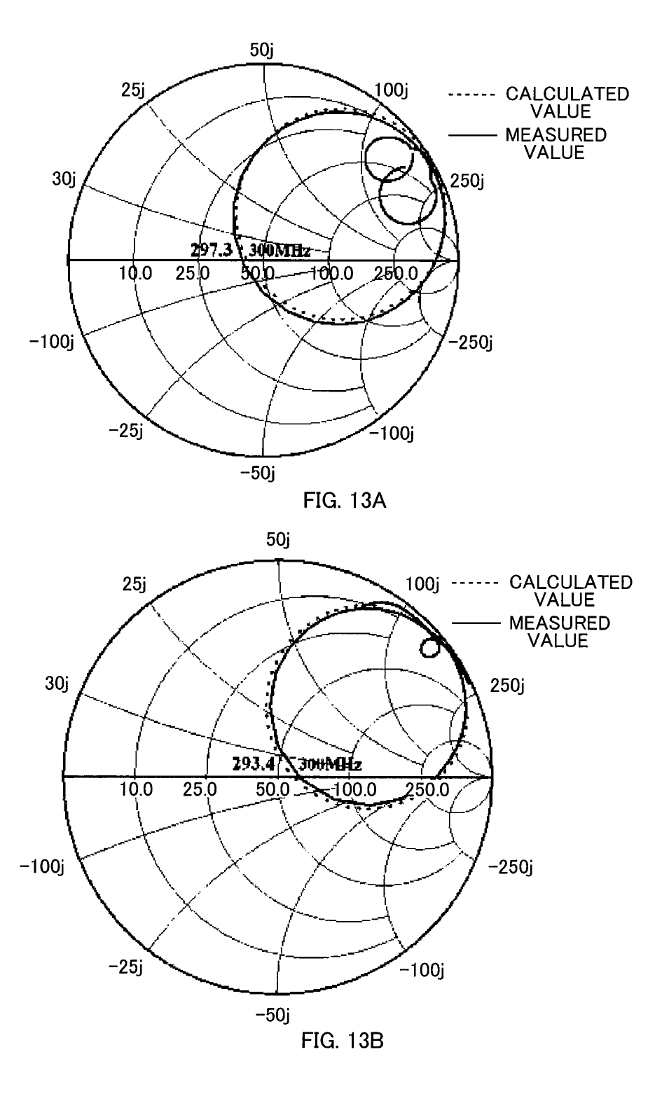

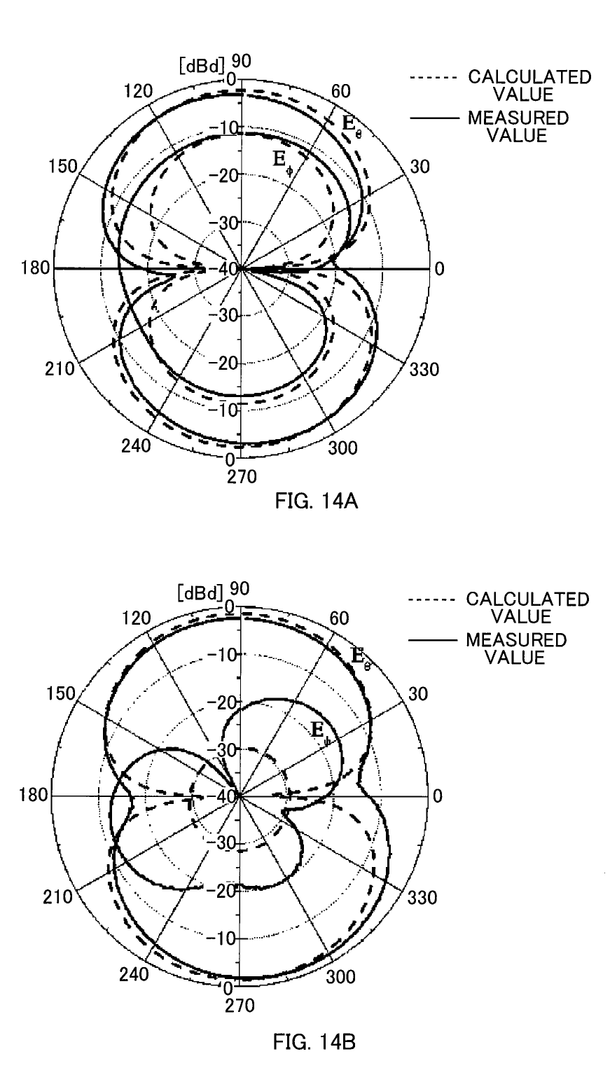

Subsequently, antennas of two types, a basic structure 260 and a folded structure 270, were prepared. The measured characteristics of the prepared antennas are shown in FIGS. 13 and 14. Validity of the calculated results through simulation will be verified by comparing them with the characteristics of the manufactured antennas.

The structural specifications of the antennas for verification are set identical to those of the antennas illustrated in FIGS. 9 and 11. In the folded structure 270, winding directions of the respective coils arranged in parallel are set opposite to each other. A coaxial cable as a feeder is provided with a Spertopf balun for balance-unbalance conversion.

First, measurement results of input impedances for the antennas for verification are shown in FIGS. 13A and 13B, indicating the results for the basic structure 260 and the folded structure 270 respectively. While the actual self-resonant frequency as measured is slightly biased from 300 MHz, the loci of the input impedance as measured are in close agreement with those as calculated.

Next, radiation characteristics of the antennas for verification are shown in FIGS. 14A and 14B, indicating the results for the basic structure 260 and the folded structure 270 respectively. The measured values are shown in dBd as compared with the values of a half-wave dipole antenna. With respect to directionality in the basic structure 260, both Eθ and Eφ as calculated are in good agreement with those as measured. On the other hand, with respect to directionality in the folded structure 270, Eφ as measured is higher than the calculated value whereas Eθ as measured well agrees with the calculated value. The presumed reason for the difference in Eφ is that since the winding directions of the respective coils arranged in parallel are set opposite to each other the Eφ value obtained through calculation has become very small, sufficient accuracy of settings could not be ensured for a cross-polarized test on actual measurement.

Next, input impedances of the basic structure 260 and the folded structure 270 when cooled with liquid nitrogen for evaluating the respective conductor resistance values Rl. The input impedance values at a room temperature, Rin(h) are 42.95Ω and 55.75Ω for the basic and the folded structures 260, 270 respectively. When cooled at −145° C., the input impedance values as measured, Rin(l) were 37.3Ω and 47.5Ω for the basic and the folded structures 260, 270 respectively. When the input impedances at a room temperature and at a cooled condition are indicated as Rin(h) and Rin(l), the relationship therebetween is expressed by the following Formula (5):

Rin(h)=Rr(h)+R1(h)

Rin(l)=Rr(l)+0.54R1(l) (5)

In Formula (5), the constant coefficient of 0.54 is a electric conductivity of a copper wire at −145° C. Since Rin(h) and Rin(l) have been measured, Rr(h) and Rl(h) can be obtained according to Formula (5). The values of Rr(h) and Rl(h) obtained through experiments are shown in Table 2.

TABLE 2
Comparison of Calculated Values and Measured Values
of Electrical Characteristics in Basic and Folded Structures

| | | Rin | Rr | Rl | η | Gr |
|---|---|---|---|---|---|---|
| Basic | Calculated | 42.14 Ω | 29.82 Ω | 12.32 Ω | −1.5 dB | −1.53 dBd |
| Struc- | Measured | 42.95 Ω | 30.67 Ω | 12.28 Ω | −1.5 dB | −2.91 dBd |
| ture | | | | | | |
| Folded | Calculated | 57.26 Ω | 43.02 Ω | 14.24 Ω | −1.24 dB | −1.26 dBd |
| Struc- | Measured | 55.75 Ω | 37.82 Ω | 17.93 Ω | −1.7 dB | −1.5 dBd |
| ture | | | | | | |

Table 2 collectively shows the calculated values of the electrical characteristics of the basic and the folded structures 260, 270 and the results of experiments respectively corresponding thereto. In both the basic and the folded structures 260, 270, the calculated values of Rr and Rl are in good agreement with their experimental results. With respect to the antenna gain Gr, almost good agreement is observed although the experimental result is a little lower than the calculated value. Resultantly, it has been confirmed that expected effects can be obtained by tap feeding.

As described hereinabove, in the normal mode helical antenna according to the embodiments of the present invention, since a tap is provided adjacent to a helical structure, a length of a tap portion can be maximized as required. Through this configuration, a required input impedance can be achieved regardless of antenna size.

Although the normal mode helical antenna according to the embodiment of the present invention is different from the conventional antennas in an operation mechanism as a transmission line, it is confirmed that the antenna of the present invention operates normally as an antenna through verification of electrical characteristics of the trial antennas by an electromagnetic field simulation.

According to the embodiments of the present invention, an ultra-small normal mode helical antenna is realized such that an input impedance can be matched to a 50Ω feeder, an antenna efficiency can be improved, and a communication distance by the antenna can be extended.

As described the present invention above according to the embodiments thereof, the above embodiments are only for facilitating understanding of the present invention and should not be construed limitative to the present invention. The present invention may be subject to any modification and improvement without departing from the scope and the spirit thereof, and all equivalents thereof are encompassed by the invention. For example, the conductor encompasses, other than a typical wire member such as an enamel wire, conductors formed in a linear shape or specific patterns including a circuit pattern formed on a printed circuit board by etching, and a circuit pattern formed by vapor deposition, thin film formation, and a semiconductor process.

What is claimed is:

1. A normal mode helical antenna comprising:
a coil made by winding a first conductor helically; and
a second conductor shorter than the first conductor having a feeding point at the middle thereof,
the second conductor disposed outside of the coil at a center part in a longitudinal direction thereof along the first conductor, and both ends of the second conductor connected to the first conductor of the coil.

2. The normal mode helical antenna according to claim 1, having a value L/λ smaller than or equal to 0.05, where L is a length of the coil and λ is a working wavelength of the antenna.

3. The normal mode helical antenna according to claim 1, further comprising a second coil made by winding a third conductor helically, the coil being identified as a first coil,
the second coil disposed at a plane-symmetric position with respect to the first coil so that a center axis thereof is parallel to a center axis of the first coil,
the ends of the second coil connected to the ends of the first coil respectively, the ends of the second coil positioned plane-symmetrically with respect to the ends of the first coil.

4. The normal mode helical antenna according to claim 3, wherein a length of the first coil is substantially equal to a length of the second coil, and the normal mode helical antenna has a value L/λ smaller than or equal to 0.05, where L is the length of the first and the second coils and λ is a working wavelength of the antenna.

5. The normal mode helical antenna according to claim 1, wherein the second conductor is disposed adjacent the first conductor while a distance between the first and the second conductors is kept constant.

6. The normal mode helical antenna according to claim 1, wherein the second conductor disposed adjacent the first conductor has a linear portion.

7. An RFID tag comprising the normal mode helical antenna according to claim 1.
